(19) United States
(12) Patent Application Publication
(10) Pub. No.: US 2014/0380328 A1
(43) Pub. Date: Dec. 25, 2014

(54) SOFTWARE MANAGEMENT SYSTEM AND COMPUTER SYSTEM

(71) Applicant: HITACHI, LTD., Tokyo (JP)

(72) Inventors: Toshiyuki UKAI, Tokyo (JP); Naonobu SUKEGAWA, Tokyo (JP)

(73) Assignee: HITACHI, LTD., Tokyo (JP)

(21) Appl. No.: 14/310,920

(22) Filed: Jun. 20, 2014

(30) Foreign Application Priority Data
Jun. 20, 2013 (JP) 2013-129209

(51) Int. Cl. G06F 9/48

(52) U.S. Cl. CPC G06F 9/4881
USPC 718/103

(57) ABSTRACT

A computer system includes: a physical computer including plural physical processors, a peripheral device connected to the plural physical processors, and a memory connected to the plural physical processors; and a management computer connected to the physical computer. The physical computer includes plural physical processor environments on each of which a virtual computer can be built, and the management computer includes an environment table indicating correspondence between plural physical processor environments each of which has the physical processor and on each of which a virtual computer can be built and an executable software program in each of the physical processor environments. When a specific software program is executed in the physical computer, a physical processor environment corresponding to a software program to be executed is selected from the plural physical processor environments by the environment table, and a virtual computer is built on the selected physical processor environment.

### CROSS-REFERENCE TO RELATED APPLICATION

The present application claims priority from Japanese Patent Application No. 2013-129209 filed on Jun. 20, 2013, the content of which is hereby incorporated by reference into this application.

### TECHNICAL FIELD OF THE INVENTION

The present invention relates to a software management system and a computer system. More particularly, the present invention relates to a software management system which is effective for software management in a plurality of virtual computers, and a computer system on which the virtual computer is built.

### BACKGROUND OF THE INVENTION

A virtualization technology which builds a plurality of virtual computers on a computer is provided. The computer on which the plurality of virtual computers are built is referred to as a physical computer in some cases in order to distinguish the computer from the virtual computers built thereon. In the physical computer, the number of physical processors each becoming a core has been increased in recent years. Accordingly, cost reduction for operation of the physical computer has been promoted by performing a job processing by using virtual computers obtained by concentrating the plurality of physical computers on a smaller number of physical computers, and building the plurality of virtual computers on the concentrated physical computers.

From a viewpoint of the cost reduction for the operation, it is required to consider a license cost for a software program for the job processing.

### SUMMARY OF THE INVENTION

In execution of a software program among software programs, a software program depending on a resource (physical resource) physically included in the physical computer exists. There is a software program which requires including a peripheral device in the physical computer as a hardware (physically) as the physical resource and which requires installing a specific peripheral device (physical resource) as being based on an assumption of execution of the software program.

As the virtualization technology, there are a plurality of technologies. For example, according to one virtualization technology, the peripheral device is emulated by emulation in each virtual computer or in a higher layer, and is provided to a guest OS (Operating System) of each virtual computer. In addition, as the other virtualization technology, there is a virtualization technology of a logic-partitioning (LPAR) method as described in Japanese Patent Application Laid-Open Publication No. 2011-253334 (Patent Document 5) or Japanese Patent Application Laid-Open Publication No. 2007-272576 (Patent Document 6). In the virtualization technology of the LPAR (Logical Partition) method, for example, the physical processor is always assigned to the virtual computer, and the peripheral device is assigned to the virtual computer.

When the software program requiring the specific peripheral device as being based on the assumption of the execution is executed by the virtual computer, the specific peripheral device is emulated by the emulation. Alternatively, the software program is executed by the virtual computer to which the specific peripheral device is assigned. In the latter case, it is required to perform such an operation (so-called migration) as copying data required for the execution of the software program from other virtual computer. This manner causes a possibility of interference with the efficient operation.

Japanese Patent Application Laid-Open Publication No. 2010-267009 (Patent Document 1), Japanese Patent Application Laid-Open Publication No. 2011-253523 (Patent Document 2), and Japanese Patent Application Laid-Open Publication No. 2010-218517 (Patent Document 3) describe a technology of the license management. In addition, Japanese Patent Application Laid-Open Publication No. 2010-86520 (Patent Document 4) describes virtualization of a CPU measurement function. However, in these Patent Documents 1 to 6, it is not recognized to cause the possibility that the efficient operation is inhibited when the software program requiring the specific peripheral device as being based on the assumption of the execution of the software program is executed by the virtual computer.

A preferred aim of the present invention is to provide a software management system and a computer system enabling the efficient operation.

The above and other preferred aims and novel characteristics of the present invention will be apparent from the description of the present specification and the accompanying drawings.

The typical ones of the inventions disclosed in the present application will be briefly described as follows.

That is, the computer system is provided with the physical computer and the management computer connected to the physical computer. The physical computer includes single or plural physical processors each of which is provided with a plurality of physical processor environments where the virtual computer can be configured. The management computer has an environment table indicating correspondence between a software program which is executable in each physical processor environment and the physical processor environment. When the software program is executed, the management computer selects the physical processor environment corresponding to the software program to be executed from the plurality of physical processor environments by using the environment table, and executes this software program in the selected physical processor environment.

In this manner, in the execution of the software program requiring the specific physical resource as being based on the assumption of the execution, the physical processor environment corresponding to the software program is selected from the environment table, and the software program is executed in the selected physical processor environment. At this time, the selected physical processor environment includes the physical processor and the specific physical resource, and therefore, the software program requiring the specific physical resource as being based on the assumption of the execution can be executed, so that the efficient operation is possible.

In an embodiment, a computer system to which the virtualization technology of the LPAR method is applied is provided. In the LPAR method, the physical peripheral device is assigned to the virtual computer. That is, the physical peripheral device is assigned to the physical processor environment. In this manner, when the physical processor environment is selected, the peripheral device in the selected physical processor environment is handled by the software program.

In addition, in an embodiment, the software program to be executed is a software program which is a target of the license. In this case, a virtual computer for executing the software program which is the target of the license and a physical processor environment where the virtual computer is configured are selected and specified from the plurality of virtual computers and the plurality of physical processor environments. In this manner, management of the software program which is the target of the license can be facilitated. In addition, in an embodiment, information related to the virtual computer which has executed the software program which is the target of the license is saved as a record. This recorded information can be used as information in the management of the license.

According to an embodiment, the software management system and the computer system enabling the efficient operation can be provided.

### BRIEF DESCRIPTIONS OF THE DRAWINGS

FIG. 1 is a block diagram illustrating a configuration of a computer system according to an embodiment;

FIG. 2 is a flowchart illustrating an initialization processing of the computer system according to an embodiment;

FIG. 3 is a schematic diagram of a table according to configuration information of a physical processor environment in an embodiment;

FIG. 4 is a schematic diagram of a table according to information of physical resource checking means in an embodiment;

FIG. 5 is a flowchart illustrating a processing of creating map information of software-and-physical processor environment in the computer system according to an embodiment;

FIG. 6 is a schematic diagram of a table according to check information of software execution qualification in an embodiment;

FIG. 7 is a schematic diagram of a table according to information of an associated software program in an embodiment;

FIG. 8 is a schematic diagram of a table according to map information between a physical processor and a physical resource in an embodiment;

FIG. 9 is a schematic diagram of a table according to map information of the software-and-physical processor environment in an embodiment;

FIG. 10 is a flowchart illustrating a processing of the computer system according to an embodiment;

FIG. 11 is a schematic diagram of a table according to designation information of transition destination in an embodiment;

FIG. 12 is a flowchart illustrating a processing of the computer system according to an embodiment;

FIG. 13 is a flowchart illustrating a processing of the computer system according to an embodiment; and

FIG. 14 is an explanatory diagram illustrating a configuration of a job net.

DESCRIPTIONS OF THE PREFERRED EMBODIMENTS

Hereinafter, an embodiment of the present invention will be described in detail based on the accompanying drawings. Note that the same components are denoted by the same reference symbols throughout the drawings for describing the embodiment, and the repetitive description thereof will be omitted.

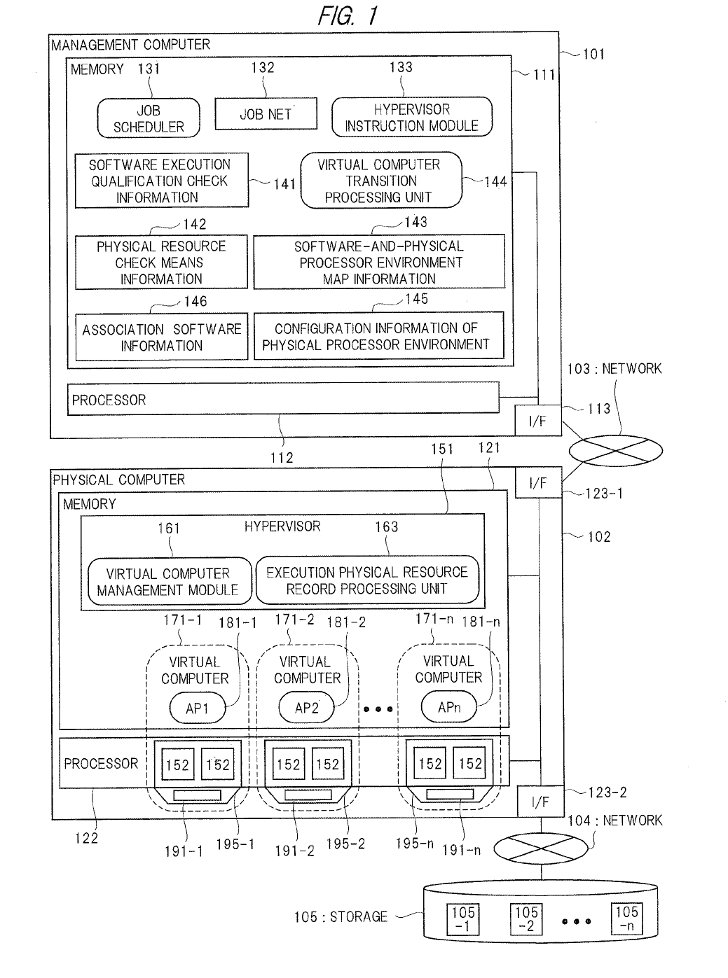

FIG. 1 is a block diagram illustrating a configuration of a computer system according to an embodiment of the present invention. In FIG. 1, a numerical symbol 102 denotes a physical computer, a numerical symbol 101 denotes a management computer, a numerical symbol 105 denotes a storage, and numerical symbols 103 and 104 denote a network. The physical computer 102 and the management computer 101 are connected to each other via the network 103. In addition, the storage 105 is connected to the physical computer 102 via the network 104.

In the management computer 101, the network 103 is connected to a processor 112 and a memory 111 which are provided inside the management computer 101 via an interface device 113. Via this interface device 113, data is transmitted/received between the network 103 and the processor 112 and the memory 111 inside the management computer 101. In addition, the physical computer 102 is provided with interface devices 123-1 and 123-2, and the interface device 123-1 connects between the network 103 and a processor 122 and a memory 121 which are provided inside the physical computer 102, so that data is transmitted/received between the network 103 and the processor 122 and memory 121. The interface device 123-2 connects between the network 104 and the processor 122 and memory 121, so that data is transmitted/received between the network 104 and the processor 122 and memory 121.

In addition, the interface devices 123-1 and 123-2 are connected to each other. In this manner, the management computer 101 and the network 104 are connected to each other, so that data can be transmitted/received therebetween. The storage 105 includes, for example, a plurality of hard disk devices, and is connected to the network 104. The storage 105 is accessed via the network 104, so that data supplied via the network 104 are written and read.

The physical computer 102 is provided with the memory 121 and the processor 122. Although not particularly limited, the processor 122 is provided with a plurality of physical processors 152. Although not particularly limited, the processor 122 is operated in accordance with a program and data which are stored in the memory 121. In this embodiment, the processor 122 is operated in a hypervisor mode in order to build a plurality of virtual computers 171-1 to 171-n on the physical computer 102. A program 151 used when the processor 122 is operated in the hypervisor mode is stored in the memory 121.

Although not particularly limited, in this embodiment, the plurality of virtual computers 171-1 to 171-n are built on the physical computer 102 by using the virtualization technology of the LPAR method. That is, the physical resources (the memory 121, the processor 122, the peripheral devices, and others) included in the physical computer 102 are logically partitioned, and each partitioned unit is functioned as the virtual computer. Although not particularly limited, in an example illustrated in FIG. 1, two physical processors 152 and a partial region of the memory 121 become one logically-partitioned unit. For simplifying explanation, each of the virtual computers 171-1, 171-2 and 171-n exemplified in FIG. 1 is built by the same unit (including two physical processors 152 and a partial region of the memory 121). As a matter of course, it is not required to build the virtual computers 171-1 to 171-n by the same unit as each other. In FIG. 1, in each of the virtual computers 171-1, 171-2, and 171-n, an area of the unit is illustrated by a dashed line.

As described above, a program for building the plurality of virtual computers on the physical computer 102 is contained in the hypervisor program 151, and is illustrated as a virtual-computer management module 161 in FIG. 1.

In each of the virtual computers 171-1 to 171-n, a guest OS is operated, and, for example, application programs (AP1 to APn) 181-1 to 181-n each of which is a software program for the job processing are executed under the guest OS.

In this embodiment, each of the virtual computers 171-1 to 171-n is set to directly use the peripheral device (input/output devices or others). That is, so-called pass-through model is adopted. As the peripheral device which is directly used by each of the virtual computers 171-1 to 171-n, interface devices 123-1 and 123-2 which connect between the virtual computer and the networks 103 and 104 or others are cited. FIG. 1 illustrates each of the interface devices 123-1 and 123-2 as one block in order to avoid the complicated drawing. However, in order to clearly specifying that the peripheral device including the interface device is directly used by each virtual computer, FIG. 1 illustrates a status in which peripheral devices 191-1 to 191-n are included in the virtual computers 171-1 to 171-n, respectively. These peripheral devices 191-1 to 191-n are functioned as, for example, the interface device 123-2.

When each of the guest OS and the application programs 181-1 to 181-n operates, the virtual computers 171-1 to 171-n perform writing and/or reading access to the storage 105 connected to the network 104 via the interface device 123-2. In this case, each of the virtual computers 171-1 to 171-n accesses to each of corresponding disk images 105-1 to 105-n in the storage 105. For example, the virtual computer 171-1 accesses to the disk image 105-1, and the virtual computer 171-2 accesses to the disk image 105-2.

The disk images 105-1 to 105-n can be formed in one hard disk. However, in this embodiment, the disk images 105-1-105-n are formed in different hard disks from each other. In addition, as the hard disks, different types of a hard disk are mixedly used. Since the hard disks are different from each other in the type, different types of an interface device are mixedly used as the peripheral devices 191-1 to 191-n which configure the interface device 123-2 in accordance with the type of the hard disk. For example, the peripheral devices 191-1, 191-2 and 191-3 are different from each other.

In the storage 105, note that a storage region is formed by combining the physical hard disks (not illustrated), and a disk region is cut out for each computer from the combined storage region, which may be the disk image (105-1 to 105-n) for the computer.

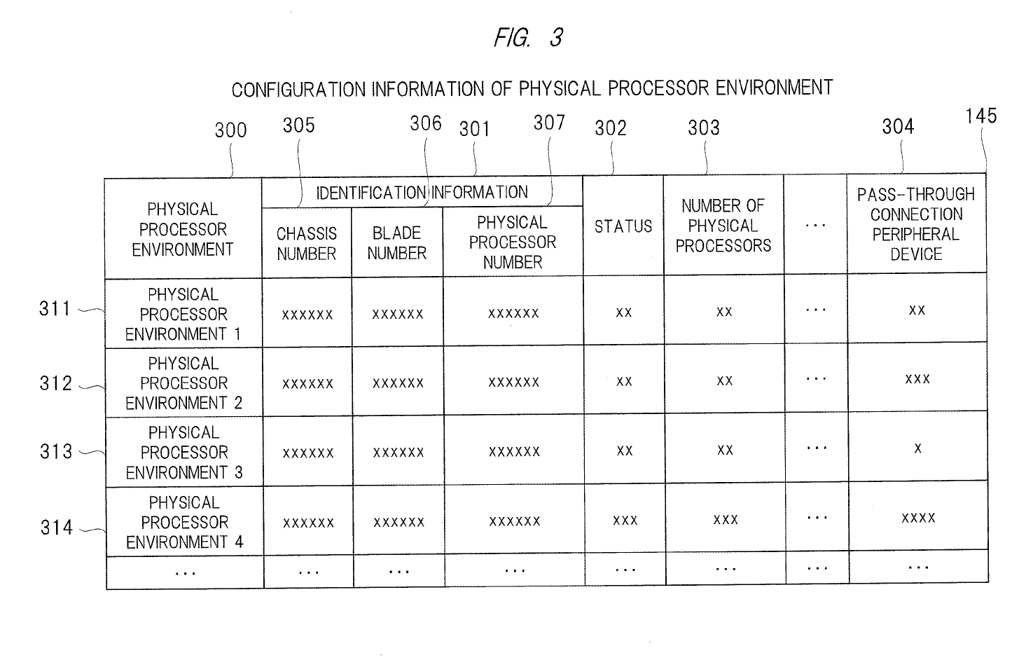

A physical configuration environment where each of the virtual computers 171-1 to 171-n can be built is referred to as the physical processor environment in the present specification. When the virtual computers 171-1, 171-2 and 171-n which are illustrated in FIG. 1 are exemplified, the physical processor environment where each virtual computer can built has two physical processors 152 and the peripheral device (191-1, 191-2 or 191-n), and is illustrated as the physical processor environment 195-1, 195-2 or 195-n. Note that, examples of the physical processor environment will be further described later by using FIG. 3.

In the program 151 which is operated in the hypervisor mode, a program which performs an execution physical resource recording processing is contained. Although explained later, when a specific software program is executed, this execution physical resource recording processing is a processing of recording information related to the virtual computer where the software program is executed and the physical processor environment where the virtual computer is built, as a history. In FIG. 1, note that this execution physical resource recording processing is illustrated as an execution physical resource recording processing unit 163.

Next, the management computer 101 will be described. The management computer 101 is provided with the processor 112 and the memory 111 as described above. The processor 112 performs a processing based on a program and data (information) which are stored in the memory 111. That is, the processing described later is achieved by the processing of the program and the data (information) which are stored in the memory 111 by the processor 112. FIG. 1 illustrates a part of the achieved processing and the information related to the processing in the memory 111. By using the processing and the information which are illustrated in FIG. 1, the management computer 101 manages the execution of the software program in the physical computer 102. Therefore, it can be regarded that the management computer 101 configures a software management system.

In FIG. 1, a numerical symbol 132 denotes a job net which stores a plurality of jobs which are to be executed in the above-described plurality of virtual computers 171-1 to 171-n. A numerical symbol 131 denotes a job scheduler which acquires a job from the plurality of jobs stored in the job net 132 and which determines a virtual computer which executes the job. A numerical symbol 133 denotes a hypervisor instruction module which provides an instruction related to the operation in the hypervisor mode to the processor 122 in the physical computer 102.

In addition, in FIG. 1, a numerical symbol 141 denotes software execution qualification check information, a numerical symbol 142 denotes physical resource checking means information, a numerical symbol 143 denotes software-and-physical processor environment map information, a numerical symbol 144 denotes a virtual computer transition processing unit, a numerical symbol 145 denotes configuration information of the physical processor environment, and a numerical symbol 146 denotes association software information. These information and processing units will be sequentially described by using a plurality of drawings below.

First, by using an input device (not illustrated) connected to the management computer 101, an administrator of the system (system administrator) registers the configuration information 145 of the physical processor environment, the physical resource checking means information 142, the software execution qualification check information 141 and the association software information 146, into the memory 111. These pieces of information can be registered by inputting the information into such a previously-formed table as having an item to be registered.

FIG. 3 illustrates a schematic diagram of a configuration information table 145 into which the configuration information 145 of the physical processor environment is registered. In the present specification, note that the same symbol is provided to the information and the table into which the information is to be/has been registered. For example, the same numerical symbol 145 is provided to the configuration information of the physical processor environment and the table into which the configuration information is to be/has been registered.

On the physical computer 102, the plurality of virtual computers 171-1 to 171-n are built. In order to achieve the building of the plurality of virtual computers, the physical computer 102 has a plurality of physical processor environments. In other words, the physical resources included in the physical computer 102 are partitioned into a plurality of physical processor environments. At this time, the partition is performed so that each physical processor environment has the physical resource by which the virtual computer can be built on the physical processor environment. A physical configuration, that is, the physical resource included in each physical processor environment is defined by the configuration information 145 of the physical processor environment.

The table (configuration information table) 145 into which the configuration information 145 of the physical processor environment is registered contains a column 300 for the physical processor environment into which a physical processor environment name specifying the physical processor environment is registered, a column 301 for identification information into which identification information for identifying the plurality of physical processor environments is registered, and a column 302 for a status on which a status of the physical processor environment is reflected. In addition, the configuration information table 145 contains a column into which the physical configuration included in each physical processor environment is registered, such as a column 303 for the number of the physical processors in to which the number of the physical processors is registered, a column 304 for the pass-through-connected peripheral device into which a peripheral device connected in the pass-through mode is registered, and others.

The column 301 for the identification information is further divided into a plurality of columns 305, 306 and 307. In this embodiment, the column 307 is a column for a physical processor number into which the physical processor number is registered. Note that, the information of the physical processor number or others is acquired by executing a specific command. Although not particularly limited, the physical computer 102 in this embodiment has a plurality of chassis and a plurality of blades each of which is loaded to the chassis, and is configured so that the plurality of physical processors are mounted on each blade. The above-described column 306 is a column for the blade number into which a number of the blade on which the physical processor is mounted is registered. In addition, the above-described column 305 is a column for the chassis number into which a number of the chassis to which the blade mounting the physical processor is loaded is registered. By using such information, that is, using the chassis number and the blade number for a physical position and using the physical processor number, one physical processor environment can be identified from the plurality of physical processor environments. Here, the chassis number, the blade number and the physical processor number are examples of the information for identifying the physical processor environment, and any information may be used if there is other identifiable information. For example, information of a socket position can be also used.

For the physical processor environment, the physical processor environment name for specifying the physical processor environment is registered in the column 300 for the physical processor environment. FIG. 3 illustrates an example in which the physical processor environments 1, 2, 3 and 4 among the plurality of physical processor environments are registered in rows 311, 312, 313 and 314 of the configuration information table 145 as an example. At this time, the number of physical processors in each physical processor environment is registered into the column 303 of the configuration information table 145, and the peripheral device in each physical processor environment is registered into the column 304 of the same. As the peripheral device registered in the column 304, note that the peripheral device which is connected in the pass-through mode is registered.

A case of registration of the physical processor environment 195-1 illustrated in FIG. 1 into the row 311 of the configuration information table 145 as an example will be described as follows. That is, in the row 311, a number of the blade on which two physical processors 152 included in the physical processor environment 195-1 are mounted and a number of the chassis to which the blade is loaded are registered into the column 306 and the column 305. In addition, in the row 311, a number of the two physical processor included in the physical processor environment 195-1 is registered into the column 307. The number of physical processors included in the physical processor environment 195-1 is registered in the column 303. In this example, information meaning two physical processors is registered. In addition, the peripheral device connected in the pass-through mode, that is, the peripheral device 191-1 is registered into the column 304 in the row 311. In this manner, the physical processor environments 195-1 to 195-n illustrated in FIG. 1 are registered into the configuration information table 145 indicating the configuration information 145 of the physical processor environment.

In the configuration information table 145, the column 302 indicates that, for example, the management computer 101 recognizes an execution status of a program in each of the physical processor environments 1, 2, 3 and 4 and reflects a result of the recognition. That is, if a program is during activation in a case in which the virtual computer is built on the physical processor environment, information indicating the execution status is stored in the column 302 in the row of the configuration information table corresponding to the physical processor environment. On the other hand, for example, if the virtual computer has not been built thereon yet, information indicating a non-execution status is stored therein.

In this manner, a plurality of physical processor environments on each of which the virtual computer can be built are set by using the configuration information table 145, that is, the configuration information 145 of the physical processor environment. In addition, a specific physical processor environment can be specified from the plurality of physical processor environments by using the identification information. Further, the status of each physical processor environment and the physical resource included in the physical processor environment can be recognized.

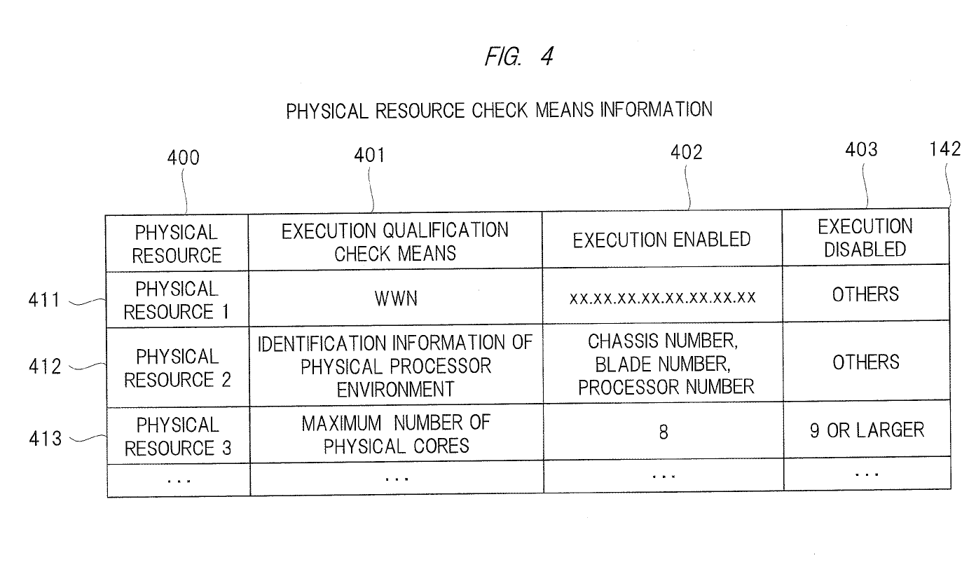

FIG. 4 illustrates a schematic diagram of the physical resource checking means information table (means information table) 142 into which the physical resource checking means information is registered. In FIG. 4, a numerical symbol 400 denotes a column for the physical resource into which a physical resource name for identifying the physical resources from each other is registered, and a numerical symbol 401 denotes a column for execution qualification checking means into which a qualification item required for executing the physical resource is registered. In addition, a numerical symbol 402 denotes a column for an execution enable status into which a condition for enabling the execution in the qualification item registered in the column 401 is registered, and a numerical symbol 403 denotes a column for an execution disable status into which a condition for disabling the execution in the qualification item registered in the column 401 is registered.

Into this means information table 142, a plurality of physical resources which are different from each other are registered in expectation of physical resources used in execution of the plurality of software programs executed by the virtual computer. Next, a registration example will be described by using FIG. 4.

In the means information table 142, the physical resources 1 to 3 are registered into rows 411 to 413 in the column 400. For the physical resource 1 (row 411), a WWN (World Wide Name) is registered as the qualification item (column 401), a value of a specific WWN is registered as the execution enable condition (column 402), and “others” which indicates all values except for the value of the specific WWN is registered as the execution disable condition (column 403). For the physical resource 2 (row 412), “the identification information of the physical processor environment” is registered as the qualification item, specific items “chassis number, blade number and processor number” are registered as the execution enable condition, and “others” which means all items except for the above-described specific items are registered as the execution disable condition. In addition, for the physical resource 3 (row 413), “the maximum number of the physical processors (the maximum number of physical cores in FIG. 4)” is registered as the qualification item, “8” is registered as the execution enable condition, and “9 or larger” is registered as the execution disable condition. Note that FIG. 4 illustrates three physical resources 1 to 3. However, the number of physical resources is not limited to this.

The above-described WWN is an identifier which is determined uniquely in the whole world, and is assigned to, for example, the peripheral device. In this manner, the execution of the physical resource 1 is enabled if the peripheral device to which a predetermined WWN value (identifier) is assigned is included, and the execution of the physical resource 1 is disabled if the peripheral device is not included. “The identification information of the physical processor environment” means the information written in the columns 305, 306 and 307 illustrated in FIG. 3. In this manner, the execution of the physical resource 2 is enabled only in the physical processor environment (for example, the physical processor environment 2 in FIG. 3) written in the column for the execution enable condition, and the execution of the physical resource 2 is disabled in other physical processor environments. Further, it is meant that the execution of the physical resource 3 is enabled in the physical processor environment where the number of physical processors is 8 or smaller.

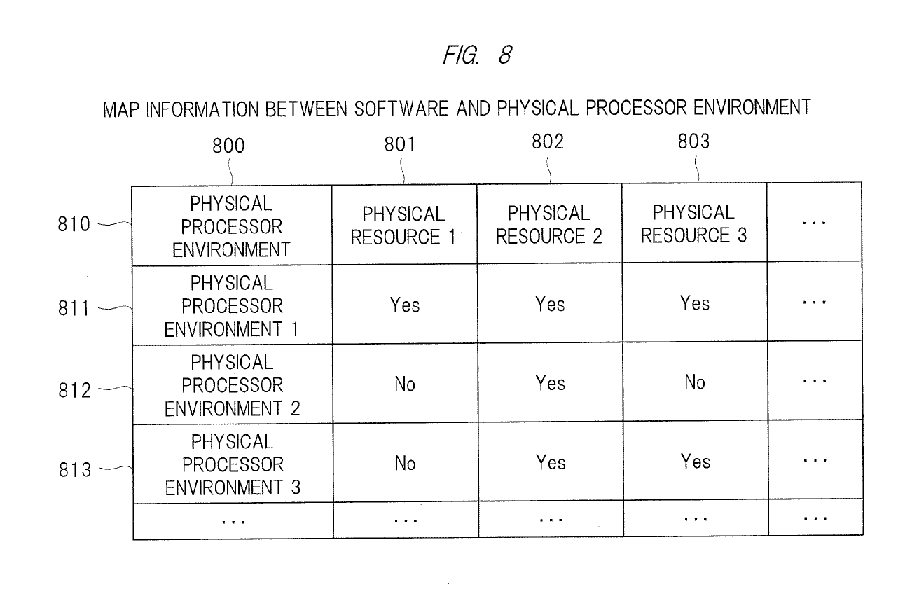

The management computer 101 performs an initialization processing by using the configuration information 145 of the physical processor environment (FIG. 3) and the physical resource checking means information 142 (FIG. 4) which are registered in as described above. By this initialization processing, information (map information) of a map between the physical processor environment and the physical resource is formed. A table (map table) of the map information between the physical processor environment and the physical resource in which the formed map information is stored is illustrated in FIG. 8. Before describing an operation of the initialization processing, the map information table will be described by using FIG. 8.

In FIG. 8, a numerical symbol 800 denotes a column for the physical processor environment into which the physical processor environment name is registered. In FIG. 8, a numerical symbol 810 denotes a row, and the physical resource names are registered into columns 801, 802 and 803 in the row 810, respectively. Into this map information table, in each of rows 811 to 813 in the column 800, the physical processor environment names described in FIG. 3, that is, the physical processor environments 1 to 4 are registered (FIG. 8 illustrates the physical processor environments 1 to 3). In addition, the physical resource 1, the physical resource 2 and the physical resource 3 which are described in FIG. 4 are registered for columns 801, 802 and 803 in the row 810, respectively. By the initialization processing described below, information indicating “Yes” or “No” is registered into an intersection between the physical processor environment (rows 811 to 813) and the physical resources (columns 801 to 803) in the map information table illustrated in FIG. 8. Note that the number of physical resources and physical processor environments are not limited to the numbers illustrated in FIG. 8.

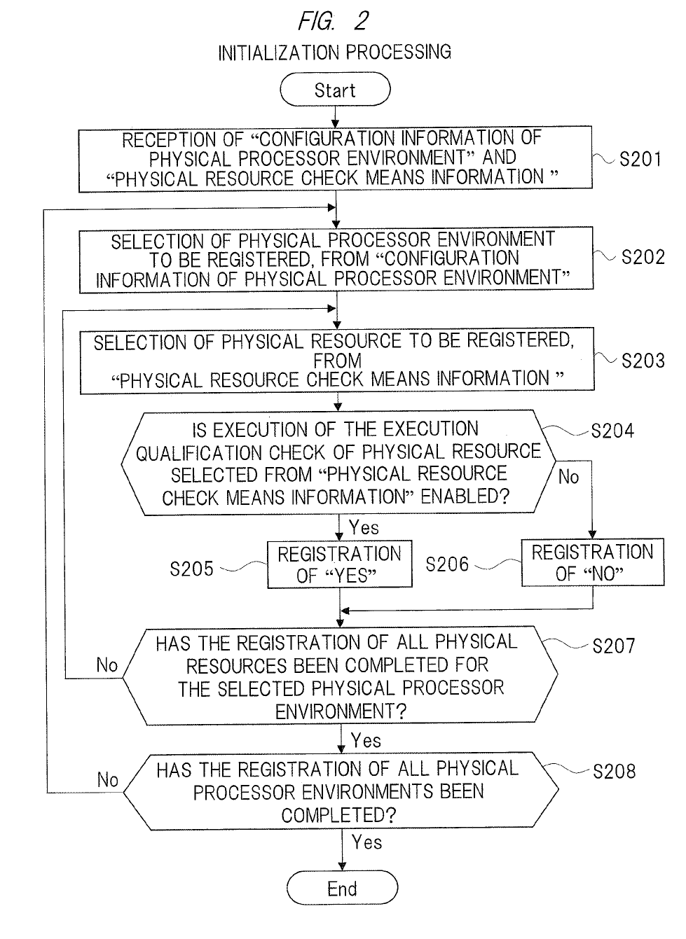

The explanation will be returned to the description for the initialization processing. FIG. 2 illustrates a flowchart illustrating operation of the initialization processing. First, the initialization processing is started by “Start”. In Step S201, the configuration information 145 of the physical processor environment illustrated in FIG. 3 and the physical resource checking means information 142 illustrated in FIG. 4 are loaded. Next, in Step S202, the physical processor environment whose information is to be registered into the map information table between the physical processor environment and the physical resource in FIG. 8 is selected from the configuration information table 145 of the physical processor environment. For example, the physical processor environment 1 (row 311) in FIG. 3 is selected. In Step S203 after the physical processor environment 1 is selected, the physical resource whose information is to be registered into the map information table between the physical processor environment and the physical resource in FIG. 8 is selected from the physical resource checking means information table 142 illustrated in FIG. 4. For example, the physical resource 1 (row 411) is selected in

FIG. 4.

In Step S204, it is checked whether or not the selected physical processor environment satisfies the qualification item (401) and the execution enable condition (402) in the selected physical resource checking means information. In the above-described example, the physical processor environment 1 (row 311) is selected, and the physical resource 1 (row 411) is selected. Therefore, in Step S204, it is checked whether or not the WWN value of the peripheral device (such as the peripheral device 195-1 in FIG. 1) included in the physical processor environment 1 matches a value of the execution enable condition (402) of the physical resource 1 in FIG. 4. If a result of this check is the unmatching, Step S206 will be executed next, and, if the result is the matching, Step S205 will be executed next.

By executing Step S205 or S206, “Yes” or “No” is registered into the intersection between the selected physical processor environment and the selected physical resource among the physical processor environments and the physical resources which are illustrated in FIG. 8. In the above-described example, in FIG. 8, “Yes” which means the matching is registered into the intersection between the physical processor environment 1 (row 811) and the physical resource 1 (column 801).

In Step S207, it is determined whether or not the checking and the registration for all the physical resources are completed in the selected physical processor environment. If the checking and the registration are not completed, the processing returns to Step S203, and is repeated until they are completed. If it is determined in Step S207 that the checking and the registration for all the physical resources are completed, Step S208 is executed. In Step S208, it is determined whether or not the checking and the registration are completed for all the physical processor environments. If the checking and the registration are not completed, the processing returns to Step S202, and the checking and the registration are performed until they are completed. On the other hand, if the checking and the registration are completed, the initialization processing is terminated (End).

In this manner, the map information between the physical processor environment and the physical resource illustrated in FIG. 8 is created. Note that the map information between the physical processor environment and the physical resource illustrated in FIG. 8 is created in the course of creation of software-and-physical processor environment map information 143 described later, and is discarded when this information is created. Therefore, the map information is not illustrated in FIG. 1. As a matter of course, the map information between the physical processor environment and the physical resource illustrated in FIG. 8 may be stored in the memory 11 as information without being discarded.

The map information between the physical processor environment and the physical resource indicates whether or not each of the physical processor environments is provided with the expected physical resource.

Next, the software execution qualification check information 141 and the association software information 146 which are registered by the system administrator will be explained.

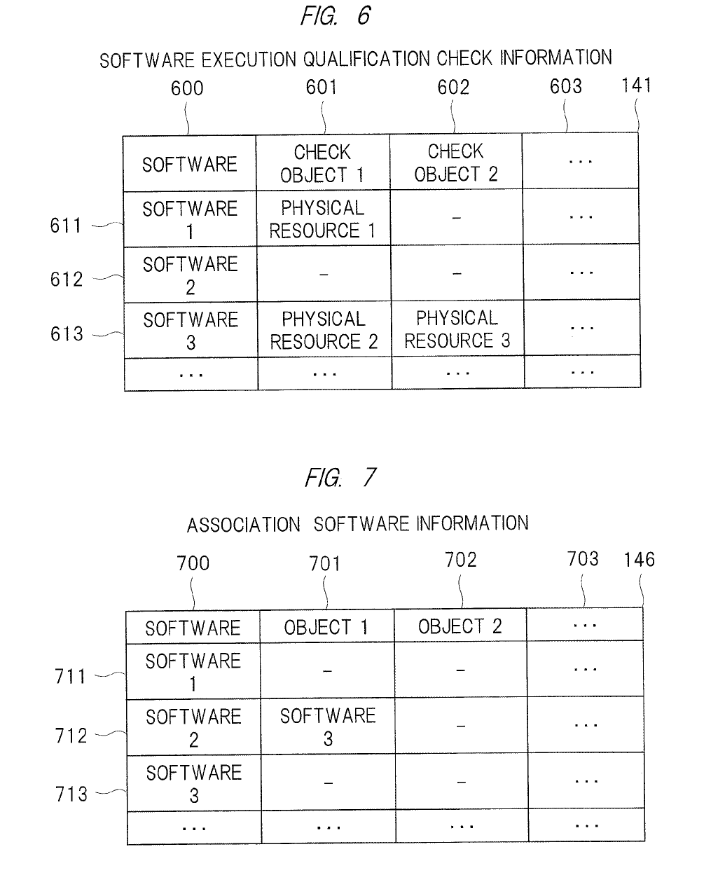

FIG. 6 is a schematic diagram illustrating a table (qualification check table) of the software execution qualification check information 141 registered by the system administrator. In FIG. 6, a numerical symbol 600 denotes a column for the software program into which a software name for specifying a software program to be executed is registered. Each of numerical symbols 601, 602 and 603 denotes a column for a check object into which the physical resource to be checked when the software program is executed is registered. Depending on the software program to be executed, a plurality of physical resources to be checked are provided in some cases, and therefore, a plurality of columns (601, 602, 603) are provided as illustrated in FIG. 6 for the column for the check object.

The registration will be explained by using FIG. 6 as an example. In the software column 600, names of the software programs to be executed (software program 1, 2 and 3 in FIG. 6) are registered into rows 611, 612 and 613, respectively. The physical resources which are assumed (required) when the software program registered into each row is executed is registered into the check object columns 601, 602 and 603, respectively. Here, each physical resource to be registered corresponds to the physical resource described in FIG. 4. That is, the physical resources 1, 2 and 3 illustrated in FIG. 6 correspond to the physical resources 1, 2 and 3 illustrated in FIG. 4, respectively.

For example, the execution of the software program 1 (row 611) is based on the assumption of the existence of the physical resource 1, and therefore, the physical resource 1 is registered into the check object column 601. For the execution of the software program 2 (row 612), there is no particular restriction in the physical resource, and therefore, the physical resources are not registered into the check object columns 601, 602 and 603. In addition, the execution of the software program 3 (row 613) is based on the assumption of the physical resources 2 and 3, and therefore, the physical resources 2 and 3 are registered into the check object columns 601 and 602.

The software program also includes a software program which invokes other software program in the course of the execution of this software program to use a processing of the other software program. In order to support the software program, the system administrator registers an association software information illustrated in FIG. 7. FIG. 7 is a schematic diagram of a table into which the association software information 146 is registered. In FIG. 7, a numerical symbol 700 denotes a column into which a software name for specifying a software program is registered, and each of numerical symbols 701, 702 and 703 is a column for the object into which an associated software name is registered. The number of the associated software program, that is, the invoked software program is not limited to one, and therefore, a plurality of columns such as 701, 702 and 703 are provided for the object column.

In an example illustrated in FIG. 7, the software program 1 and 3 (rows 711 and 713) do not have the invoked (associated) software program in the course of the execution of the software program, no software program is registered into the object column. On the other hand, the software program 2 (row 712) invokes the software program 3 in the course of the execution of the software program 2. Therefore, the software program 3 is registered into the object column 701 because of the association.

Next, a processing of creating the environment map information which indicates a relation between the software program and the physical processor environment will be explained by using the software execution qualification check information 141 illustrated in FIG. 6, the association software information 146 illustrated in FIG. 7, and the map information between the physical processor environment and the physical resource illustrated in FIG. 8.

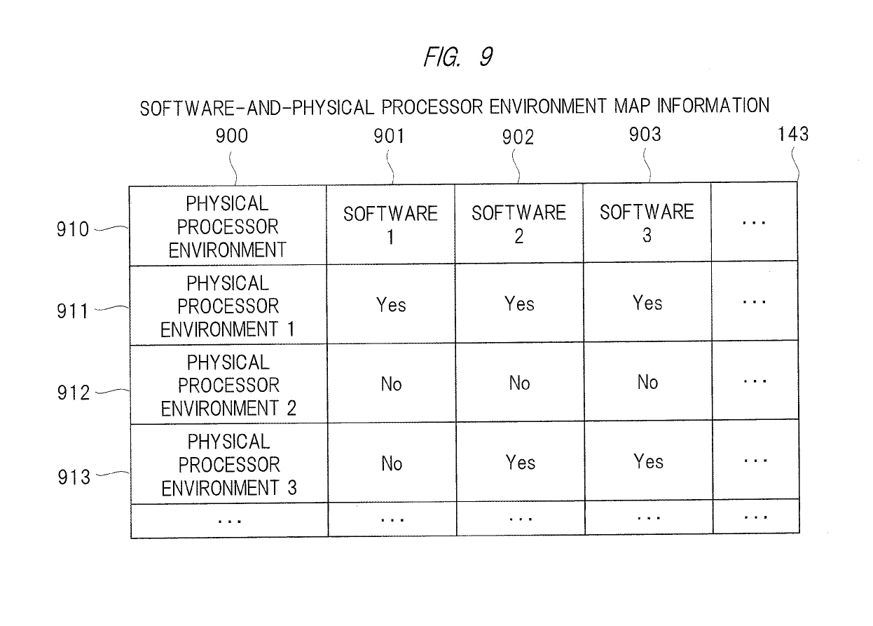

Also here, before the processing of creating the environment map information is explained, a table of the software-and-physical processor environment map information 143 for storing the environment map information will be explained. FIG. 9 is a schematic diagram of the software-and-physical processor environment map information table (environment map information table or environment table) 143 for storing the software-and-physical processor environment map information 143. In FIG. 9, a numerical symbol 900 denotes a column for the physical processor environment in which the physical processor name for specifying the physical processor environment is stored. In this environment map information table 143, physical processor environments 1, 2, 3 and 4 described in FIG. 3 are registered in rows 911, 912 and 913 in a column 900, respectively. Note that the physical processor environment 4 is omitted in FIG. 9.

In FIG. 9, a numerical symbol 910 denotes a row for the environment map information table 143, and the software name for specifying the software program to be executed is registered into each of columns 901, 902 and 903 in the row 910. Into each intersection between the rows 911 to 913 and the columns 901 to 903 in the environment map information table 143, information indicating whether or not the software program registered in the column is executable in the physical processor environment registered in the row is registered.

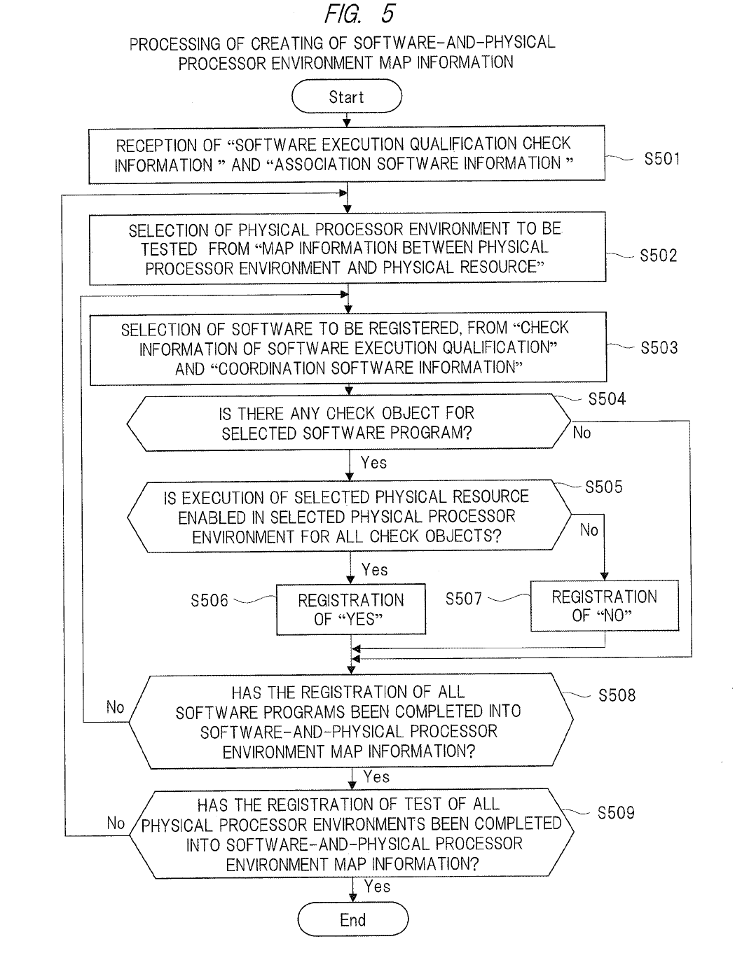

Next, the processing of creating the environment map information, that is, the software-and-physical processor environment map information 143 will be explained. FIG. 5 is a flowchart illustrating the processing of creating the software-and-physical processor environment map information 143. The software-and-physical processor environment map information 143 is created based on the software execution qualification check information 141 (FIG. 6), the association software information 146 (FIG. 7), and the previously-created map information between the physical processor environment and the physical resource (FIG. 8) described above. The created software-and-physical processor environment map information 143 is registered into this table illustrated in FIG. 9.

First, in FIG. 5 the processing of the creation is started by “Start”. Next, in Step S501, the software execution qualification check information 141 and the association software information 146 which have been explained in FIGS. 6 and 7 are loaded.

In Step S502, the physical processor environment to be tested is selected from the map information between the physical processor environment and the physical resource described in FIG. 8. In addition, in Step S503, the software program to be executed (to be registered) is selected from the previously-loaded software execution qualification check information 141 and the previously-loaded association software information 146. Next, in Step S504, it is checked whether or not the physical resource to be checked exists for the previously-selected software program. If the physical resource exists, Step S505 is executed next, and, if the physical resource does not exist, Step S508 is executed next.

In Step S505, it is determined whether or not the execution of the physical resource to be checked for which the existence is determined is enabled in the previously-selected physical processor environment. This determination is achieved by checking the information indicating “Yes” or “No” registered into the intersection between the column and the row on the table corresponding to the selected physical processor environment in the table illustrated in FIG. 8. If it is determined in Step S505 that the execution is enabled, Step S506 is executed next, and, if it is determined therein that the execution is disabled, Step S507 is executed next.

In Steps S506 and S507, the information is registered into the environment map information table 143 illustrated in FIG. 9 is performed. That is, if it is determined in Step S505 that the execution is enabled, the information “Yes” indicating that the execution is enabled is registered (S506) into the intersection between the row and the column on the environment map information table 143 (FIG. 9) which corresponds to the selected physical processor environment and the selected software program. On the other hand, if it is determined in Step S505 that the execution is disabled, the information “No” indicating that the execution is disabled is registered (S507) into the intersection between the row and the column on the environment map information table 143 (FIG. 9) which corresponds to the selected physical processor environment and the selected software program. After the registration, Step S508 is executed.

Here, an example of a processing from Step S502 up to S507 will be described by using FIGS. 6, 7 and 8.

For example, in Step S502, the physical processor environment 1 in the row 811 of the map information table (FIG. 8) is selected as the physical processor environment to be tested. In addition, in Step S503, the software program 3 in, for example, the row 613 (FIG. 6) and the row 713 (FIG. 7) is selected as the software program to be registered from the qualification check information table 141 (FIG. 6) and the association software information table (FIG. 7). In Step S504, it is determined whether or not the physical resource which is the check object exists for the previously-selected software program 3 by using tables 141 and 146 of FIGS. 6 and 7. For the software program 3, it is confirmed from the table 141 illustrated in FIG. 6 that the physical resource 2 and the physical resource 3 exist as the check object 1 (column 601) and the check object 2 (column 602).

On the other hand, for the software program 3, it is confirmed from the table 146 illustrated in FIG. 7 that the associated object software program is not registered. If the associated object software program is registered here as similar to the software program 2, also for the object software program (for example, the software program 3 when the selected software program is the software program 2), it is confirmed whether or not the physical resource which is the check object exists by using FIG. 6.

When it is confirmed that the physical resources 2 and the physical resources 3 exist as the check object, the row 811 corresponding to the physical processor environment 1 which is selected to be examined is selected from rows 811 to 813 in the map information table illustrated in FIG. 8. In addition, columns 802 and 803 corresponding to the physical resources 2 and 3 whose existence has been confirmed are selected from columns 801 to 803 in the map information table illustrated in FIG. 8. The information registered into each intersection between the selected row 811 and the selected columns 802 and 803 is “Yes” in the map information table illustrated in FIG. 8. That is, it is determined in Step S505 that the execution of each of the physical resources 2 and 3 is enabled in the physical processor environment 1. In other words, this means that the execution of the selected software program 3 is enabled in the physical processor environment 1.

Since the execution enable status is determined in Step S505, Step S506 is executed. Here, in the environment map information table 143 illustrated in FIG. 9, the information “Yes” indicating the execution enable status is registered into an intersection between a row 911 corresponding to the selected physical processor environment 1 among a plurality of rows 911 to 913 and a column 903 corresponding to the selected software program 3 among the plurality of columns 901 to 903. As a matter of course, when it is determined in Step S505 that the execution is disabled, the information “No” indicating the execution disable status is registered thereto.

The explanation will be returned to the explanation of FIG. 5. In Step S508, for each of other software program in the physical processor environment to be tested, it is determined whether or not the software-and-physical processor environment map information is registered. This can be achieved by determining whether or not the information is registered into all the columns in the row corresponding to the physical processor environment to be tested in the environment map information table 143 illustrated in FIG. 9. If the registration is completed for all of the software programs, Step S509 is executed next. If the registration is not completed for all of the software programs, the processing returns to Step S503, and Step S503 to Step S508 are repeated so that the registration for all of the software programs is completed.

In Step S509, it is determined whether or not the registration is completed for all the physical processor environments. That is, it is determined whether the registration of the information is completed for all the rows in the environment map information table 143 illustrated in FIG. 9. If all of the registrations are completed, the processing of creating the software-and-physical processor environment map information 143 is terminated (End). On the other hand, if the registration is not completed for all the physical processor environments, the processing returns to Step S502, and Step S502 to Step S509 are repeated. In this manner, the registration for all the physical processor environments is executed.

The software-and-physical processor environment map information 143 created here indicates in which one of the physical processor environments the software program requiring the existence of the specific physical resource as being based on the assumption of the operation of the software program can be executed.

Next, a processing of determining a transition destination of the virtual computer will be explained by using the software-and-physical processor environment map information 143 created as described above. By this processing, a software program requiring the specific physical resource (peripheral device or others) as being based on the assumption of the execution of the software program is provided to a suitable physical processor environment, and the virtual computer is built by using the physical processor environment, so that such a software program can be executed, and the computer system can be efficiently operated.

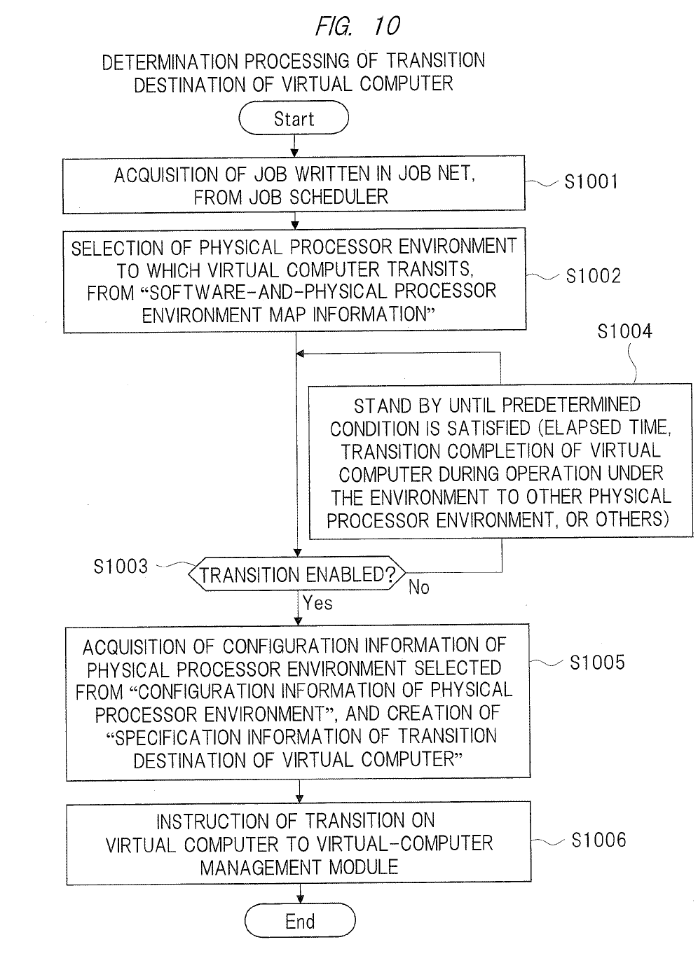

FIG. 10 is a flowchart illustrating an operation of the processing of determining the transition destination of the virtual computer. This processing is achieved by executing a program in the management computer 101. Therefore, in FIG. 1, the processing is illustrated as the virtual-computer transition processing unit 144 in the memory 111.

First, in FIG. 10, when the processing is started (Start), Step S1001 is executed. In Step S1001, the job scheduler 131 (FIG. 1) acquires a job from a plurality of jobs illustrated in the job net 132 (FIG. 1).

In Step S1002, in order to execute the software program corresponding to the acquired job by the virtual computer, the physical processor environment is selected based on this software program from the software-and-physical processor environment map information 143 (FIG. 9) described above. That is, the software program corresponding to the acquired job is selected from a plurality of software programs registered in each column (901 to 903) in the row 910 in the environment map information table 143 illustrated in FIG. 9. In the environment map information table 143, a column which has the selected software program is selected, and a row in which the information “Yes” indicating the execution enable status is stored is selected in the selected column, and the physical processor environment assigned to this selected row is selected as the physical processor environment corresponding to this software program.

In Step S1003, a virtual computer which uses the physical processor environment selected in Step S1002 as the physical resource is activated, and it is determined whether or not the job transition to the virtual computer is enabled. In this Step S1003, it is determined whether or not the selected physical processor environment has been already used by the virtual computer so that the job (software program) is during the execution. In this determination, for example, the status of the physical processor environment stored in the column 302 is referred to in the configuration information table 145 illustrated in FIG. 3. On the status stored in this column 302 which has been explained in FIG. 3, information indicating whether each physical processor environment is in the operating status or not is reflected. Therefore, by checking the status in the column 302 (FIG. 3), the status of the physical processor environment can be recognized.

For example, if it is determined that the virtual computer is not during the activation in the selected physical processor environment, it is determined in the selected physical processor environment that the job transition to a virtual computer activated to be used as the physical resource is enabled. If it is determined that the transition is enabled, Step S1005 is executed next. On the other hand, if it is determined that the transition is disabled, Step S1004 is executed next.

In Step S1004, the processing is in a standby status until a predetermined condition is satisfied. When the predetermined condition is satisfied, Step S1003 is executed again. Here, the predetermined condition means, for example, a condition when predetermined time elapses or when the transition of the virtual computer activated by using the selected physical processor environment to other physical processor environment is completed.

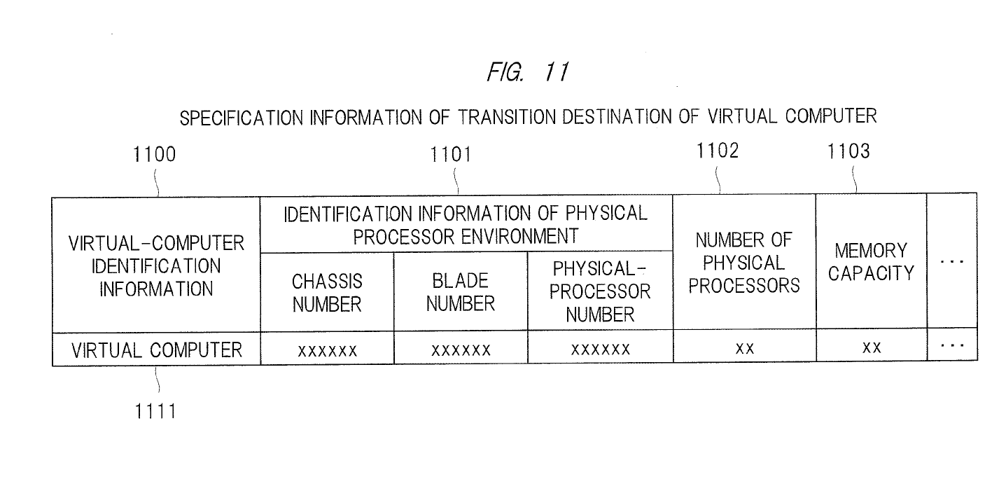

On the other hand, in Step S1005, since the job transition is enabled, the configuration information of the physical processor environment which corresponds to the physical processor environment selected in Step S1002 is acquired from the configuration information 145 of the physical processor environment illustrated in FIG. 3. Based on the acquired configuration information of the physical processor environment, specification information of the transition destination of the virtual computer is created. A configuration example of the specification information of the transition destination of the virtual computer is illustrated in FIG. 11 as a schematic diagram.

The specification information of the transition destination of the virtual computer is stored in a table as illustrated in FIG. 11. Items stored as the specification information of the transition destination of the virtual computer include: virtual-computer identification information 1100; physical-processor-environment identification information 1101; the number of the physical processors 1102; a memory capacity 1103; and physical resource information of the peripheral device or others (not illustrated). Here, the physical-processor-environment identification information 1101 is configured of the chassis number, the blade number, and the physical processor number as similar to the description in FIG. 3. In Step S1005 (FIG. 10), when it is determined that the transition is enabled, the configuration information of the selected physical processor environment (identification information, the number of physical processors, the memory capacity, and the physical resource information) is acquired from the configuration information 145 of the physical processor environment illustrated in FIG. 3, and is stored in the table illustrated in FIG. 11. In such storage, for example, a virtual computer name 1111 is registered for identification into the virtual-computer identification information 1100 in order to identify the virtual computer activated in the selected physical processor environment.

The specification information of the transition destination of the virtual computer created in Step S1005 (FIG. 10) is provided to the virtual computer management module 161 in the physical computer 102 by the hypervisor instruction module 133 (FIG. 1) in Step S1006 (FIG. 10) so as to give an instruction on the transition to the virtual computer, and the processing is terminated (End).

As a matter of course, on the physical computer, the virtual computer is built and activated by using the physical processor environment specified by this identification information based on the physical-processor-environment identification information 1101 contained in the specification information of the transition destination of the virtual computer or others. In the activated virtual computer, the transition job (software program) is executed.

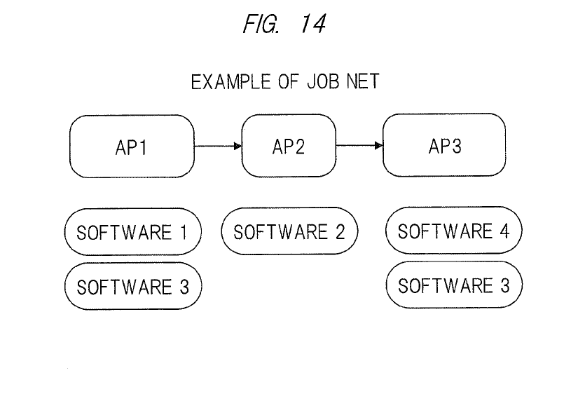

FIG. 14 illustrates an example of the job net registered into the job net 132. In FIG. 14, jobs AP1, AP2 and AP3 are registered, are scheduled by the job scheduler 131, and are sequentially executed. Here, the software program 1 and 3 are executed in the job AP1, and the software program 2 is executed in the job AP2, and the software program 4 and 3 are executed in the job AP3.

The virtual computer which executes the transition job is built on the physical processor environment including the physical resource required for the execution of the job (software program). Therefore, such data transition as required for executing the software program from the virtual computer built on the physical processor environment not including the physical resource required for the execution of the software program can be reduced, and the computer system can be efficiently operated. In addition, since the data transition can be reduced, security can be also improved.

FIG. 13 is a flowchart illustrating an operation of a response processing to the job scheduler. In FIG. 13, the management computer 101 (FIG. 1) receives a result from the virtual computer management module 161 in Step S1301. Next, in Step S1302, the management computer 101 instructs the job scheduler 131 to schedule the job. When the virtual computer executes, for example, the software program 1 (3) in the job AP1 illustrated in FIG. 14, the result is supplied from the virtual-computer management module 161 to the management computer 101. The management computer 101 instructs the job scheduler 131 to schedule. In response to this instruction, the processing illustrated in FIG. 10 is started. In this manner, even if the software program 2 is a software program which requires the specific physical resource, the physical processor environment including the specific physical resource is selected, and the virtual computer is built on the selected physical processor environment, and the software program 2 is executed. The same goes for other software program 1, 3 and 4.

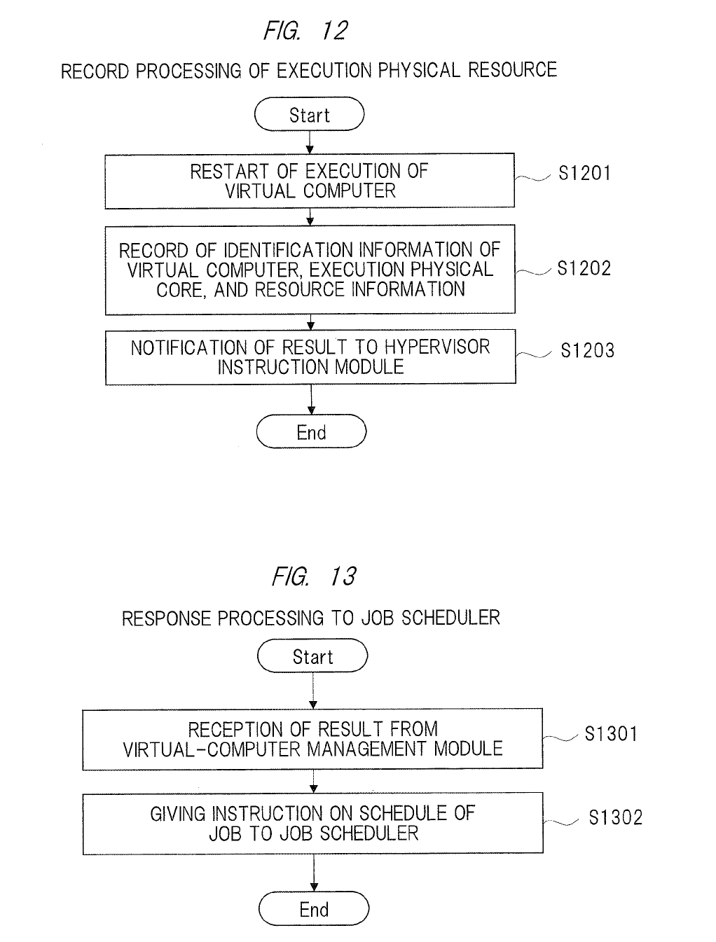

FIG. 12 is a flowchart illustrating an operation of a processing of recording information of the physical resource or others used in the execution of the software program by the virtual computer. This processing is executed in the physical computer 102 which is operated in the hypervisor mode. Therefore, in FIG. 1, a function of performing this processing is written in the memory 121 of the physical computer as the executing-physical-resource recording processing unit 163. In addition, FIG. 12 illustrates an operation of recording information obtained from restart of the execution in the virtual computer.

First, in Step S1201, the execution by the virtual computer (for example, virtual computer 171-1 of FIG. 1) is restarted. By the restart of the execution by the virtual computer, for example, the specification information of the transition destination of the virtual computer illustrated in FIG. 11 is created, and is supplied to the virtual-computer management module 161 (FIG. 1).

The virtual computer name 1111 contained in the specification information of the transition destination of this virtual computer, the processor number contained in the physical-processor-environment identification information 1101, and the physical resource information are recorded in Step S1202. In Step S1203, information of the results recorded in Step S1202 is notified of to the hypervisor instruction module 133 in the management computer 101.

In the embodiment, the software program using the specific physical resource such as the peripheral device is executed by the virtual computer in the physical processor environment including the specific physical resource at the job scheduling. Meanwhile, there is such a money charge example for a license related to the software program as determined in accordance with the number of physical processors or the number of virtual processors. In this case, it is concerned that even the software program requiring the specific physical resource as being based on the assumption causes a cost associated with the license depending on the number of physical processors or the virtual processors. In the embodiment, the software program requiring the specific physical resource as being based on the assumption is executed in only the physical processor environment having the specific physical resource. Therefore, the cost associated with the license can be reduced. In addition, as explained by using FIG. 12, the record of the execution of the software program using the specific physical resource is saved. The saved record can be also submitted as evidence.

In the above-described embodiment, the computer system separately including the physical computer and the management computer has been explained. However, the management computer may be a part of the physical computer. In addition, in the embodiment, the explanation has been made as exemplifying several physical processor environments, several physical resources, several software programs, and others. However, in the present invention, the numbers of pieces are not limited to these numbers.

Each of the physical processors described in the above-described embodiment may be one processor embedded in one semiconductor integrated circuit device, and may be each of a plurality of physical cores embedded in one semiconductor integrated circuit device. When one processor embedded in one semiconductor integrated circuit device corresponds to one physical processor, a plurality of physical processors are achieved by a plurality of semiconductor integrated circuit devices. In addition, when one physical processor corresponds to one of a plurality of physical cores embedded in one semiconductor integrated circuit device, a plurality of physical processors are achieved by one semiconductor integrated circuit device. In the present specification and drawings, note that the physical processor is referred to as the physical core in some cases.

In the foregoing, the invention made by the inventors has been concretely described based on the embodiment. However, it is needless to say that the present invention is not limited to the foregoing embodiment and various modifications and alterations can be made within the scope of the present invention.

What is claimed is:

1. A computer system, comprising:
a physical computer including a plurality of physical processors, a peripheral device connected to each of the plurality of physical processors, and a memory connected to the plurality of physical processors; and
a management computer connected to the physical computer,
wherein the management computer includes an environment table indicating correspondence between a plurality of physical processor environments each of which has the physical processor and on each of which a virtual computer can be built and a software program which is executable in each of the physical processor environments, and,
when a software program is executed in the physical computer, a physical processor environment corresponding to a software program to be executed is selected from the plurality of physical processor environments by using the environment table.

2. The computer system according to claim 1,
wherein the management computer includes a job net in which a plurality of software programs are registered and a job scheduler which acquires a software program to be executed from the job net, and
a physical processor environment corresponding to the acquired software program is selected from the plurality of physical processor environments.

3. The computer system according to claim 2,
wherein the management computer includes:
a qualification check table indicating correspondence between the software program and a physical resource in the physical computer which requires the physical resource as being based on an assumption of execution of the software program; and
a map table indicating correspondence between each of the plurality of physical processor environments and the physical resource in the physical computer, and
the environment table is formed based on the qualification check table and the map table.

4. The computer system according to claim 3, wherein the physical resource in the physical computer includes the peripheral device and the plurality of physical processors.

5. The computer system according to claim 4,
wherein the software program includes a software program which is an object of a license.

6. The computer system according to claim 5,
wherein, when the software program is executed, the physical computer forms and records information of a physical processor environment where the software program has been executed.

7. A software management system connected to a physical computer including a plurality of physical processor environments each of which has a physical processor and on each of which a virtual computer can be built,
wherein the software management system includes an environment table indicating correspondence between each of the plurality of physical processor environments and a software program which is executable in the physical processor environment, and,
when a plurality of software programs are executed, a physical processor environment corresponding to a software program to be executed is selected from the plurality of physical processor environments by using the environment table.

8. The software management system according to claim 7,
wherein the software management system includes a job net in which the plurality of software programs are registered and a job scheduler which acquires a software program to be executed from the job net, and
a physical processor environment corresponding to the acquired software program is selected from the a plurality of physical processor environments.

9. The software management system according to claim 8,
wherein the software management system includes:
a qualification check table indicating correspondence between a software program to be executed and a in the physical computer which requires the physical resource as being based on an assumption of execution of each of the plurality of software programs; and
a map table indicating correspondence between each of the plurality of physical processor environments and the physical resource in the physical computer, and
the environment table is formed based on the check table and the map table.

10. The software management system according to claim 9,
wherein the plurality of software programs include a software program which is an object of a license.
